(19) United States
(12) Patent Application Publication
(10) Pub. No.: US 2005/0185153 A1
(43) Pub. Date: Aug. 25, 2005

(54) Wide angle-of-view and high resolution rear projection optical system

(76) Inventor: Sung-tae Kim, Seoul (KR)

Correspondence Address: STANZIONE & KIM, LLP, 1740 N STREET, N.W., FIRST FLOOR, WASHINGTON, DC, 20036, US

(21) Appl. No.: 11/030,359

(22) Filed: Jan. 7, 2005

(30) Foreign Application Priority Data
Feb. 24, 2004 (KR) 2004-12407

(51) Int. Cl. G03B 21/60

(52) U.S. Cl. 353/102

(57) ABSTRACT

A rear projection optical system to enlarge and project images of an image-forming panel onto a rear side of a screen includes a front lens group disposed in a vicinity of the screen, and having first, second, and third lenses having a negative power respectively, and fourth and fifth lenses having a positive power respectively, a rear lens group disposed in a vicinity of the panel, and having a first bonding lens including a sixth lens with a positive power and a seventh lens with a negative power, a second bonding lens including an eighth lens with a negative power and a ninth lens with a positive power, and a tenth lens with a negative power, and an iris disposed between the front lens group and the rear lens group to control an amount of light. The rear projection optical system enables a wide angle-of-view (91 degrees), a high resolution, and a reduced depth of a display device.

### CROSS-REFERENCE TO RELATED APPLICATIONS

This application claims the benefit under 35 U.S.C. § 119 of Korean Application No. 2004-12407, filed Feb. 24, 2004, in the Korean Intellectual Property Office, the disclosure of which is incorporated herein in its entirety and by reference.

### BACKGROUND OF THE INVENTION

1. Field of the Invention

The present general inventive concept relates to a projection optical system useable with a projection-type image display apparatus, and more particularly, to a rear projection lens system configured to form a projection distance short enough to implement a wide angle-of-view and a high resolution.

2. Description of the Related Art

Recently, due to a demand for a wide angle-of-view and a high resolution of an image display apparatus, image projection devices which project and enlarge small-sized images onto a large screen by use of a projection optical system are rapidly spreading. In particular, rear projection devices, which project an image signal from behind the screen, are widely used as projection TVs.

Conventional rear projection devices comprise a light source, a Liquid Crystal Display (LCD) or a Digital Micromirror Device (DMD) panel as a display device forming images by use of light emitted from the light source, a screen, and a projection optical system enlarging by a certain magnification factor and projecting the formed images of the panel onto the screen.

However, as the screen onto which the projection optical system focuses images becomes gradually larger in size, a higher resolution is required, and a wider angle-of-view is also required for the thinner devices. A description of a conventional projection optical system is provided below.

FIG. 1 is a view illustrating a structure of a conventional projection optical system. Referring to FIG. 1, the conventional projection optical system has a front lens group comprising first to fifth lenses 1, 2, 3, 4, and 5, with the first lens disposed nearest to a screen (not shown), a rear lens group comprising sixth to tenth lenses 6, 7, 8, 9, and 10, and an iris 20 disposed between the front lens group and the rear lens group. The rear lens group has a negative power and primarily reduces various kinds of aberrations of light that are incident through a prism 30, reflected from a digital micromirror display (DMD) panel 40 and passing therethrough. Further, the aberrations are re-compensated due to a strong positive power of the fourth and fifth lenses 4 and 5. The first lens 1 mostly compensates distorted aberrations, and the second and third lenses 2 and 3 compensate for coma-aberration, astigmatism, and spherical aberration. The front lens group is constructed to have a negative power in order to widen an angle-of-view.

However, since unwanted images are displayed on the screen due to ghost images occurring by the rear lens group, the conventional projection optical system has a problem that the rear lens group must have a different curvature depending on its position. Also, since the iris 20 is disposed close to the sixth lens 6, it is difficult to insert a new iris to control an amount of light. Further, the conventional projection optical system does not provide a sufficient angle-of-view. Accordingly, an improved projection optical system is needed.

### SUMMARY OF THE INVENTION

The present general inventive concept provides a projection optical system having a wide angle-of-view, a high resolution, and less distortion.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a rear projection optical system to enlarge and project images of an image-forming panel onto a rear side of a screen, the rear projection optical system comprising a front lens group disposed in a vicinity of the screen, and having first, second, and third lenses that have a negative power, respectively, and fourth and fifth lenses that have a positive power, respectively, a rear lens group disposed in a vicinity of the image-forming panel, and having a first bonding lens comprising a sixth lens with a positive power and a seventh lens with a negative power, a second bonding lens comprising an eighth lens with a negative power and a ninth lens with a positive power, and a tenth lens with a negative power, and an iris disposed between the front lens group and the rear lens group to control an amount of light.

The tenth lens has a first surface with a positive curvature and a second surface with a negative curvature, satisfying an equation as follows:

$$\begin{matrix}0.046 < \frac{\vert {\sum }_{i = 6}^{7} {p}_{i} + {\sum }_{i = 8}^{9} {p}_{i} \vert}{{{Q}_{i = 6}}^{9} {n}_{i} {v}_{i}} \times 1000 < 0.05 \\ \frac{OBJ}{BFL} \times m = K , K \leq 0.35\end{matrix} ,$$

where, pᵢ, nᵢ, and vᵢ denote a refractive power, refraction index, and dispersion of an i-th lens, respectively, OBJ (Object Distance) denotes a distance from the screen to the first lens, BFL (Back Focal Length) denotes a distance from the tenth lens to the image-forming panel, and m denotes a magnifying power of all of the lenses.

The OBJ, BFL, and m may be set to 593, 26.5, and 0.0154, respectively.

Further, the iris may be disposed spaced a predetermined distance from a center of a first surface of the sixth lens, satisfying an equation as follows:

$$1.55 < \frac{{\sum }_{i = 6}^{7} {n}_{i}}{{d}_{11}} + \frac{{\sum }_{i = 8}^{9} {n}_{i}}{{d}_{11}} < 1.58$$

where, d₁₁ denotes a center distance between the iris and the sixth lens, and nᵢ denotes a refractive power of the i-th lens.

The d₁₁ and the corresponding nᵢ may be set as follows:
d₁₁=4.19, n₆=1.48749, n₇=1.75520, n₈=1.84666, and n₉=1.48749.

The fourth lens has a first and a second surface that respectively have a negative curvature, the fifth lens has a first surface with a positive curvature and a second surface with a negative curvature, the first bonding lens has a first surface, a bonding surface, and a second surface that have a positive curvature, a positive curvature, and a negative curvature, respectively, and an equation as below is satisfied:

$$7.30 < \frac{{\sum }_{i = 4}^{5} {p}_{i}}{{\sum }_{i = 1}^{2} {p}_{b i}} < 7.60 ,$$

where, pᵢ denotes a refractive power of the i-th lens, and p_{bi} denotes a refractive power of the i-th bonding lens.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating a structure of a conventional rear projection optical system;

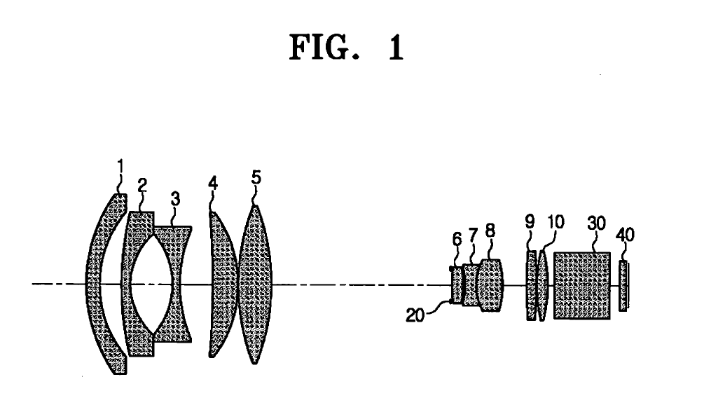

FIG. 2 is a view illustrating a structure of a rear projection optical system according to an embodiment of the present general inventive concept;

FIG. 3 is a view illustrating aberration characteristics of the rear projection optical system of FIG. 2; and

FIG. 4 is a view illustrating a practical application of the rear projection optical system of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

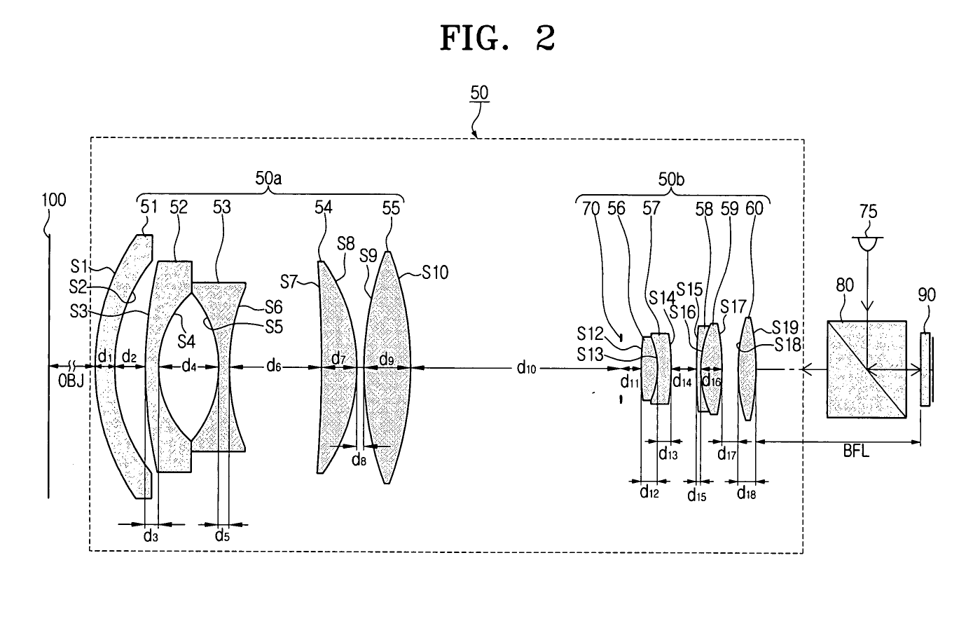

FIG. 2 is a view illustrating a structure of a rear projection optical system according to an embodiment of the present general inventive concept. The rear projection optical system of FIG. 2 can be applied to an image projection device employing a DMD panel, such as for example, a projection TV. FIG. 2 illustrates main components of the image projection device for the sake of explanation. Referring to FIG. 2, the image projection device has a screen 100, the rear projection optical system 50, a lamp 75, a prism 80, and a DMD panel 90 to form images. The rear projection optical system 50 according to the embodiment of FIG. 2 is structured to project the images of the DMD panel 90 having an effective area of 0.79″ (20.1 mm) onto a 46″ screen and a 56″ screen when a 50″ screen is considered as a standard screen.

The rear projection optical system 50 is structured with a front lens group 50a having five lenses 51, 52, 53, 54 and 55 disposed near the screen 100, a rear lens group 50b having five lenses 56, 57, 58, 59 and 60 disposed near the DMD panel 90, and an iris 70 disposed between the front lens group 50a and the rear lens group 50b to control an amount of light. Thus, the rear projection optical system 50 includes ten lenses 51, 52, 53, 54, 55, 56, 57, 58, 59 and 60 in total. As shown in FIG. 2, reference numerals are assigned to lenses Lᵢ so that Lᵢ refers to an i-th lens from the screen 100. Similarly, reference numerals are assigned to lens surfaces Sᵢ, a center thickness of a lens, and a center distance dᵢ between lenses in order, with reference to the screen 100. For example, the first lens 51 is denoted as L₁, the second lens 52 as L₂, a first surface of the first lens 51 as S₁, a second surface of the first lens 51 as S₂, the center thickness of the first lens 51 as d₁, and the center distance between the first lens 51 and the second lens 52 as d₂.

The front lens group 50a has five lenses including the lenses L₁, L₂, L₃, L₄ and L₅ (51, 52, 53, 54 and 55), and characteristics of the individual lenses are as follows. The lens L₁ (51) and the lens L₂ (52) have first surfaces S_{1 and S}₃ and second surfaces S₂ and S₄, respectively, formed in a positive (+) curvature, so that the lenses L₁ and L₂ (51 and 52) have a negative (−) power, and the lens L₃ (53) has a first surface S₅ formed in a negative curvature and a second surface S₆ formed in a positive curvature, so that the lens L₃ (53) has a negative power. Further, the lens L₄ (54) has first and second surfaces S₇ and S₈ that are formed in a negative curvature, so that the lens L₄ (54) has a positive power, and the lens L₅ (55) has a first surface S₉ formed in a positive curvature and a second surface S₁₀ formed in a negative curvature, so that the lens L₅ (55) has a positive power.

The rear lens group 50b has five lenses including the lenses L₆, L₇, L₈, L₉ and L₁₀ (56, 57, 58, 59, and 60). The lens L₆ (56) and the lens L₇ (57) are bonded by an ultraviolet (UV) bonding, or the like, to form a first bonding lens, and the lens L₈ (58) and the lens L₉ (59) are bonded to form a second bonding lens.

The lens L₆ (56) of the first bonding lens has a first surface S₁₂ formed in a positive curvature and a second surface S₁₃ formed in a negative curvature, so that the lens L₆ (56) has a positive power, and the lens L₇ (57) has a first surface S₁₃ formed in a negative curvature and a second surface S₁₄ formed in a negative curvature, so that the lens L₇ (57) has a negative power. The lens L₈ (58) of the second bonding lens has a first surface S₁₅ formed in a positive curvature and a second surface S₁₆ formed in a positive curvature, so that the lens L₈ (58) has a negative power, and the lens L₉ (59) has a first surface S₁₆ formed in a positive curvature and a second surface S₁₇ formed in a negative curvature, so that the lens L₉ (59) has a positive power. Further, the lens L₁₀ (60) has a first surface S₁₈ formed in a positive curvature and a second surface S₁₉ formed in a negative curvature, so that the lens L₁₀ (60) has a negative power.

In order that the images of the DMD panel 90 pass through the rear lens group 50b and the front lens group 50a, and are projected and clearly focused on the screen 100, distortion reduction is performed. The lens L₁ (51) can be an aspheric lens composed of a plastic material to reduce distortion. Further, in order to obtain a wide angle-of-view, the lenses L_{1 to L}₃ (51, 52, and 53), which are disposed near the screen 40, are structured to have a negative power, and, in order to reduce an angle of light, the lens L₄ (54) and the lens L₅ (55) are structured to have a positive power. Further, since the lens L₁ to the lens L₃ (51, 52, and 53) have a negative power, aberration is reduced due to a partial offset resulting from interaction among the lenses L1, L2 and L3 (51, 52 and 53).

The first and second bonding lenses reduce aberrations not eliminated by the front lens group 50a. In particular, the first and second bonding lenses can compensate for chromatic aberration. The first and second bonding lenses can be formed of FD-series and low-dispersion materials that are low-priced. Further, the lens L₁₀ (60) has a refractive power set to control a final performance correction and an angle of light incident on the DMD panel 90. The lenses (51, 52, 53, 54, 55, 56, 57, 58, 59 and 60) are structured as described above so that clear images can be displayed in precise focus on the screen 100 with less distortion.

The rear projection optical system 50 according to the embodiment of FIG. 2 satisfies Equations 1-3 as follows.

$$\begin{matrix}0.046 < \frac{\vert {\sum }_{i = 6}^{7} {p}_{i} + {\sum }_{i = 8}^{9} {p}_{i} \vert}{{{Q}_{i = 6}}^{9} {n}_{i} {v}_{i}} \times 1000 < 0.05 \\ \frac{OBJ}{BFL} \times m = K , K \leq 0.35\end{matrix} , \qquad [ Equation 1 ]$$

where, pᵢ, nᵢ, and vᵢ denote a refractive power, refraction index, and dispersion of the lens L₁, respectively, OBJ (Object Distance) denotes a distance from the screen 100 to the lens L₁ (51), BFL (Back Focal Length) denotes a distance from the lens L₁₀ (60) to the DMD panel 90, and m denotes a magnifying power of all of the lenses (51, 52, 53, 54, 55, 56, 57, 58, 59 and 60). Here, the refractive power pᵢ is defined as the reciprocal of a focal length fᵢ.

$$1.55 < \frac{{\sum }_{i = 6}^{7} {n}_{i}}{{d}_{11}} + \frac{{\sum }_{i = 8}^{9} {n}_{i}}{{d}_{11}} < 1.58 , \qquad [ Equation 2 ]$$

where, d₁₁ denotes a center distance between the iris 70 and the lens L₆ (56), and nᵢ denotes a refractive power of the lens Lᵢ.

$$7.30 < \frac{{\sum }_{i = 4}^{5} {p}_{i}}{{\sum }_{i = 1}^{2} {p}_{b i}} < 7.60 , \qquad [ Equation 3 ]$$

where, pᵢ denotes a refractive power of the lens Lᵢ, and p_{bi} denotes a refractive power of the i-th bonding lens.

Table 1 illustrates exemplary values of the lenses (51, 52, 53, 54, 55, 56, 57, 58, 59 and 60) of the rear projection optical system 50 according to an embodiment of the present general inventive concept.

TABLE 1

| Surface | Curvature | Thickness, | Refraction | |
|---|---|---|---|---|
| number (Sᵢ) | Radius | distance (dᵢ) | index (n_{d}) | Dispersion (V_{d}) |
| *1 | 110.638 | 5.21 | 1.49200 | 57.1 |
| *2 | 39.691 | 10.99 | | |
| 3 | 103.871 | 2.50 | 1.65844 | 50.9 |
| 4 | 29.588 | 18.76 | | |
| 5 | −45.121 | 3.97 | 1.65844 | 50.9 |
| 6 | 45.121 | 30.36 | | |
| 7 | −822.751 | 10.00 | 1.60342 | 38.0 |
| 8 | −63.890 | 1.46 | | |
| 9 | 84.950 | 11.00 | 1.62290 | 58.1 |
| 10 | −221.455 | 75.00 | | |
| Stop | Infinity | 4.19 | | |
| 12 | 75.739 | 5.00 | 1.48749 | 70.4 |
| 13 | −22.786 | 4.50 | 1.75520 | 27.5 |
| 14 | −68.618 | 8.29 | | |
| 15 | 191.645 | 1.20 | 1.84666 | 23.8 |
| 16 | 29.267 | 6.99 | 1.48749 | 70.4 |
| 17 | −60.727 | 5.11 | | |
| 18 | 54.057 | 5.46 | 1.78472 | 25.7 |
| 19 | −74.049 | 2.90 | | |
| Prism | Infinity | 25.0 | 1.51680 | 64.2 |
| Imager | Infinity | 0.00 | | |

The Equation of two aspheric surfaces S₁ and S₂ of the lens L₁ (51) can be expressed below.

$$\begin{matrix}x = \frac{C {Y}^{2}}{1 + \sqrt{1 - ( K + 1 ) {C}^{2} {Y}^{2}}} + a {Y}^{4} + b {Y}^{6} + c {Y}^{8} + d {Y}^{10} \\ C = 1 / R\end{matrix} , \qquad [ Equation 4 ]$$

where, Y denotes a distance from an optical axis, C denotes a curvature, and R denotes a radius. Table 2 illustrates a Conic constant and aspheric surface coefficients (a, b, c, and d) of the surfaces S₁ and S₂ of the lens L₁ (51).

TABLE 2

| | S₁ | S₂ |
|---|---|---|
| K | −0.848776 | −0.407388 |
| A | 0.432770E−05 | 0.120734E−05 |
| B | −0.170360E−08 | 0.218927E−09 |
| C | 0.655455E−12 | −0.435046E−11 |
| D | −0.710030E−17 | 0.148104E−14 |

Table 3 illustrates a magnifying factor, an effective focal length (EFL), an F number the distance (object distance (OBJ)) from the screen 100 to the lens L₁ (51), an angle-of-view (FOV), and wavelengths of RGB light sources.

TABLE 3

| m | EFL | F# | OBJ | FOV | R | G | B |
|---|---|---|---|---|---|---|---|
| 0.0154 | 9.6864 | 2.5 | 593 mm | 91 | 640 mm | 550 mm | 440 mm |
| | | | | degrees | | | |

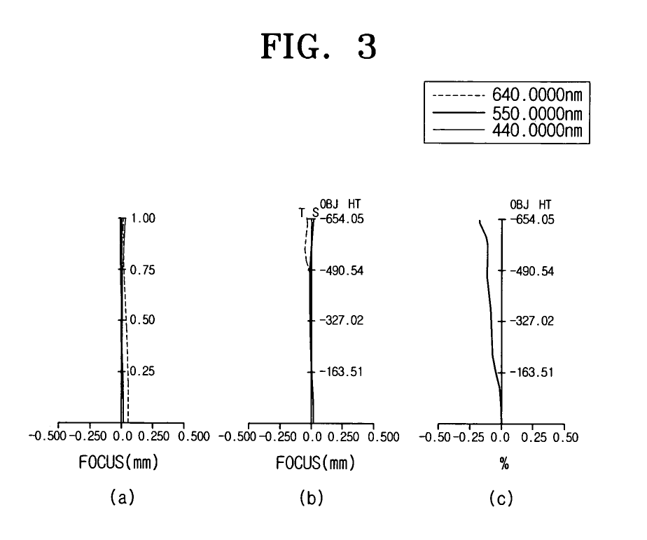

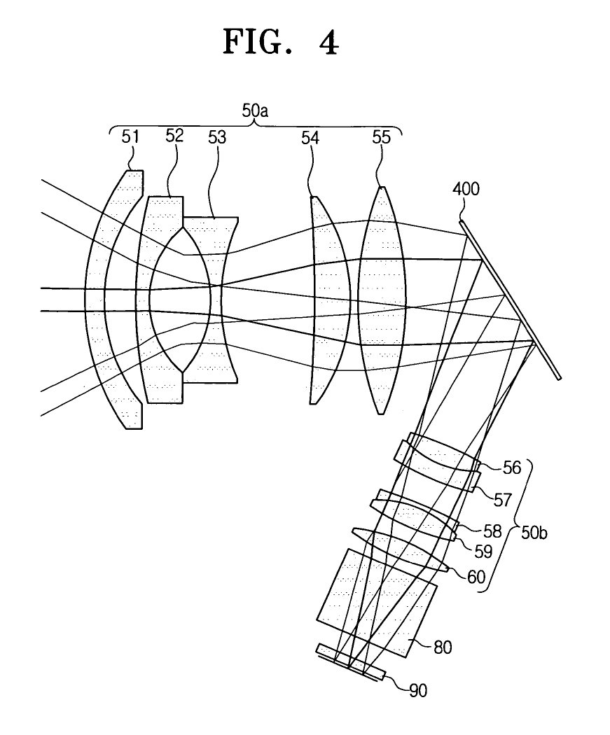

FIG. 3 illustrates characteristics of spherical aberration (a), astigmatism (b), and distortion (c) of the rear projection optical system 50 having the exemplary values as described above. Further, FIG. 4 illustrates that a depth of a display device can be reduced by insertion of a reflection mirror 400 between the front lens group 50a and the rear lens group 50b, according to an embodiment of the present general inventive concept.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A rear projection optical system to enlarge and project images of an image-forming panel onto a rear side of a screen, comprising:
a front lens group disposed in a vicinity of the screen, and comprising first, second, and third lenses having a negative power respectively, and fourth and fifth lenses having a positive power respectively;
a rear lens group disposed in a vicinity of the image-forming panel, and having a first bonding lens comprising a sixth lens with a positive power and a seventh lens with a negative power, a second bonding lens comprising an eighth lens with a negative power and a ninth lens with a positive power, and a tenth lens with a negative power; and
an iris disposed between the front lens group and the rear lens group to control an amount of light.

2. The rear projection optical system as claimed in claim 1, wherein the tenth lens has a first surface with a positive curvature and a second surface with a negative curvature, satisfying an equation as follows:
$$\begin{matrix}0.046 < \frac{\vert {\sum }_{i = 6}^{7} {p}_{i} + {\sum }_{i = 8}^{9} {p}_{i} \vert}{{{Q}_{i = 6}}^{9} {n}_{i} {v}_{i}} \times 1000 < 0.05 \\ \frac{OBJ}{BFL} \times m = K , K \leq 0.35\end{matrix} ,$$
where, pᵢ, nᵢ, and vᵢ denote a refractive power, refraction index, and dispersion of an i-th lens, respectively, OBJ (Object Distance) denotes a distance from the screen to the first lens, BFL (Back Focal Length) denotes a distance from the tenth lens to the panel, and m denotes a magnifying power of the entire lenses.

3. The rear projection optical system as claimed in claim 2, wherein the OBJ, BFL, and m are set to 593, 26.5, and 0.0154, respectively.

4. The rear projection optical system as claimed in claim 1, wherein the iris is disposed spaced a predetermined distance from a center of a first surface of the sixth lens, satisfying an equation as follows:
$$1.55 < \frac{{\sum }_{i = 6}^{7} {n}_{i}}{{d}_{11}} + \frac{{\sum }_{i = 8}^{9} {n}_{i}}{{d}_{11}} < 1.58$$
where, d₁₁ denotes the predetermined distance between the iris and the center of the first surface of the sixth lens, and nᵢ denotes a refractive power of the i-th lens.

5. The rear projection optical system as claimed in claim 4, wherein d₁₁ and corresponding nᵢ are set as follows:
d₁₁=4.19, n₆=1.48749, n₇=1.75520, n₈=1.84666, and n₉=1.48749.

6. The rear projection optical system as claimed in claim 1, wherein the fourth lens has first and second surfaces that respectively have a negative curvature, the fifth lens has a first surface with a positive curvature and a second surface with a negative curvature, the first bonding lens has a first surface, a bonding surface, and a second surface that have a positive curvature, a positive curvature, and a negative curvature, respectively, and an equation as below is satisfied:
$$7.30 < \frac{{\sum }_{i = 4}^{5} {p}_{i}}{{\sum }_{i = 1}^{2} {p}_{b i}} < 7.60 ,$$
where, pᵢ denotes a refractive power of the i-th lens, and p_{bi} denotes a refractive power of the i-th bonding lens.

7. The rear projection optical system as claimed in claim 1, wherein the sixth and seventh lenses are bonded by ultraviolet bonding to form the first bonding lens, and the eighth and ninth lenses are bonded by ultraviolet bonding to form the second bonding lens.

8. The rear projection optical system as claimed in claim 1, wherein the first lens in an aspheric lens.

9. A display apparatus having an image forming panel to form images, a screen, and a projection optical system to enlarge the images and display the images on the screen, the projection optical system comprising:
a front lens group disposed near the screen and comprising first, second, third, fourth, and fifth lenses; and
a rear lens group disposed near the image forming panel comprising:
a sixth lens and a seventh lens bonded together,
an eighth lens and a ninth lens bonded together, and
a tenth lens.

10. The display apparatus as claimed in claim 9, wherein the projection optical system further comprises an iris disposed in between the front lens group and the rear lens group to control an amount of light.

11. The display apparatus as claimed in claim 9, wherein the first, second, third, seventh, eighth, and tenth lenses are diverging lenses, and the fourth, fifth, sixth, and ninth lenses are converging lenses.

12. The display apparatus as claimed in claim ˜9, wherein the first lens is an aspheric lens.

13. The display apparatus as claimed in claim 9, wherein the sixth and seventh lenses are bonded by ultraviolet bonding, and the eighth and ninth lenses are bonded by ultraviolet bonding.

14. The display apparatus as claimed in claim 13, wherein the sixth, seventh, eighth, and ninth lenses are formed of FD-series and low dispersion materials.

15. The display apparatus as claimed in claim 9, wherein the projection optical system further comprises a mirror, the rear lens group is disposed below the front lens group, and the images of the image forming panel are passed through the rear lens group and reflected from the mirror to the front lens group.

16. A projection optical system usable with a display apparatus having an image-forming panel to form images and a screen to display the images thereon, comprising:
a first lens group disposed along a focal path near the screen including a plurality of lenses to enlarge and project the images of the image-forming panel onto the screen; and
a second lens group disposed along the focal path near the image-forming panel, and including a first set of bonded lenses and a second set of bonded lenses.

17. The projection optical system as claimed in claim 16, wherein the first and second set of bonded lenses each comprise two lenses bonded together by ultraviolet bonding.

18. The projection optical system as claimed in claim 17, wherein one of the two lenses in each of the first and second set of bonded lenses has a positive power, and the other one of the two lenses of the first and second set of bonded lenses has a negative power.

19. The projection optical system as claimed in claim 16, wherein the first and second set of bonded lenses reduce aberrations of the images projected through the plurality of lenses.

20. The projection optical system as claimed in claim 19, wherein the first and second set of bonded lenses compensate for chromatic aberrations of the images projected through the plurality of lenses.

21. The projection optical system as claimed in claim 16, wherein the first and second set of bonded lenses are disposed near a rear end of the focal path.

22. A display apparatus comprising:
an image forming panel to form images;
a screen to display the images thereon;
a plurality of rear lenses disposed near the image forming panel, and including a first set of bonded lenses and a second set of bonded lenses; and
a plurality of front lenses disposed near the screen,
wherein the images are projected along a focal path from the image forming panel through the plurality of rear lenses and the plurality of front lenses to the screen, and a position of the plurality of rear lenses with respect to the plurality of front lenses can be adjusted.

23. The display apparatus as claimed in claim 22, wherein the position of the plurality of rear lenses is determined according to a depth of the display apparatus.

24. The display apparatus as claimed in claim 23, wherein the plurality of rear lenses is disposed below the plurality of front lenses to reduce the depth of the display apparatus.

25. The display apparatus as claimed in claim 24, further comprising a mirror disposed in the focal path between the plurality of rear lenses and the plurality of front lenses, and angularly positioned to reflect the images projected through the plurality of rear lenses to the plurality of front lenses.

26. The display apparatus as claimed in claim 22, wherein the position of the plurality of rear lenses is determined according to a width of the screen.

27. The display apparatus as claimed in claim 22, wherein the position of the plurality of rear lenses is determined according to an aberration of the images projected through the plurality of rear lenses and the plurality of front lenses.

28. The display apparatus as claimed in claim 22, wherein the position of the plurality of rear lenses in determined according a resolution quality of the images.

29. The display apparatus as claimed in claim 22, further comprising an iris disposed in the focal path between the plurality of rear lenses and the plurality of front lenses, and a predetermined distance from the plurality of rear lenses to control an amount of light.

30. A projection optical system to project light onto a screen, comprising:
a front lens group including a plurality of negative powered lenses reducing distortion and aberrations of the light, and a plurality of positive powered lenses reducing an angle of the light; and
a rear lens group including first and second bonding lenses reducing aberrations of the light not eliminated by the front lens group, and a refractive lens to control a final performance correction and an angle of the light.

31. The projection optical system as claimed in claim 30, wherein the plurality of negative powered lenses reduce the aberrations of the light according to interactions among the plurality of negative powered lenses.

32. The projection optical system as claimed in claim 30, wherein at least one of the plurality of negative powered lenses is an aspheric lens.

33. The projection optical system as claimed in claim 30, wherein the first and second bonding lenses compensate for chromatic aberrations of the light.

34. The projection optical system as claimed in claim 30, wherein the first and second bonding lenses each comprises two lenses bonded together by ultraviolet bonding.

35. The projection optical system as claimed in claim 34, wherein one of the two lenses of each of the first and second bonding lenses is a positive powered lens, and the other one of the two lenses of each of the first and second bonding lenses is a negative powered lens.

36. The projection optical system as claimed in claim 30, wherein the refractive lens is a negative powered lens.

37. The projection optical system as claimed in claim 30, further comprising an iris disposed between the front lens group and the rear lens group, and a predetermined distance from the rear lens group to control an amount of the light.
